(19) United States
(12) Patent Application Publication
(10) Pub. No.: US 2006/0106640 A1
(43) Pub. Date: May 18, 2006

(54) Medical credit assurance method

(76) Inventor: Douglas Neil Deline, Midland, MI (US)

Correspondence Address: Douglas N. Deline, 1183 E. Phillips Ct., Midland, MI, 48640, US

(21) Appl. No.: 10/990,563

(22) Filed: Nov. 18, 2004

(51) Int. Cl. G06Q 10/00; G06Q 40/00

(52) U.S. Cl. 705/2; 705/4; 705/39

(57) ABSTRACT

A business method that provides for payment of medical expenses for members of an association, comprising, establishing contractual agreements between the association and a multiplicity of medical service providers that are obligated to provide medical services to members of the association at rates that are pre-negotiated or otherwise agreed to with the association; extending to members of the association a line of credit to be used to pay for medical services received from any of said medical service providers; paying said medical service providers for services rendered to said member according to the prenegotiated or otherwise agreed to rate schedule; charging the member's account for payments made to a medical service provider for services received by the member; and receiving reimbursement from the member for amounts so charged to the member's account.

### BACKGROUND OF THE INVENTION

The present invention relates to a method for conducting a business. In particular, the present invention relates to a method for providing members of an association with a pre-established line of credit for use in payment of medical expenses.

Medical insurance is a well known method for providing payment for medical services. However, many individuals are denied medical insurance due to an inability to pay required premiums or due to a preexisting medical condition that renders such individual a poor risk. The lack of insurance can result in catastrophic economic impact due to the fact that service providers often charge such individuals increased amounts for medical services rendered due to lack of credit worthiness. Often, persons who are without insurance but are otherwise willing and able to pay for medical services, are charged fees by medical providers that are far greater than fees charged for identical procedures rendered to those covered by insurance. This is because negotiated fee structures often exist between service providers and insurance companies, governmental agencies, or other third party payers of medical services.

Increasingly however, many service providers add additional charges for services provided even to patients covered by insurance plans due to increased costs for carrying such accounts, such as billing costs, lost interest on deferred reimbursement, extra accounting costs, and, increasingly, loss of time in treating patients due to interference or delays due to third party review of medical treatment choices or refusal to pay for certain services by the insurance company. Thus, charges assessed under negotiated pricing for services may actually be higher than would be achievable if such added costs could be avoided. Coincidentally, many patients, even if covered under a private or public insurance plan, are increasingly frustrated by lack of choice as to medical providers or procedures, requisite pre-authorization for treatment, high insurance premiums, deductibles and required co-payments for services received, limitations on coverage, and lack of treatment options.

Individual patients are often able to arrange for credit in order to pay for services rendered by individual physicians and other service providers or to use a consumer credit to pay for medical services. However, such accounts have not necessarily involved negotiated or reduced fees for services rendered. At least there has been no assurance that the fees charged were as low as possible or at least equivalent to the fees charged under negotiated fee schedules. Moreover, these arrangements for special payment terms would only exist with one or a limited number of service providers. Additionally, because use of a person's consumer credit card requires consent, a person who is incapacitated or unable to provide informed consent to medical procedures may not receive needed medical care, even if carrying a personal credit card.

### SUMMARY OF THE INVENTION

According to the present invention, there is provided a business method that provides for payment of medical expenses received by or on behalf of members of an association, comprising,
establishing contractual agreements between the association and a multiplicity of medical service providers that are obligated to provide medical services to members of the association at rates that are pre-negotiated or otherwise agreed to with the association;
extending to members of the association a line of credit to be used to pay for medical services received from any of said medical service providers;
paying said medical service providers for services rendered to said member according to the prenegotiated or otherwise agreed to rate schedule;
charging the member's account for payments made to a medical service provider for services received by the member; and
receiving reimbursement from the member for amounts so charged to the member's account.

In accordance with the present method, a medical service provider receives immediate or prompt payment for services rendered to a member of the medical association thereby avoiding the need for the medical service provider to conduct individual credit worthiness investigations on patients or potential patients. In exchange, members of the association, upon providing proof of membership in the medical credit association are assured they will receive prompt medical treatment, at prenegotiated or otherwise agreeable rates. Desirably, such rates are equivalent or even less than the rates charged to insured patients for similar services. The medical credit association pays for services received by the member and chargs the member's account accordingly. Payment is thereafter received by the association from the member, in addition to any finance charges and or other fees assessed by the association. Accordingly, the method of the invention combines the credit and financing attributes of the consumer finance industry with the standardized or pre-negotiated group rate services from the medical insurance business.

### DETAILED DESCRIPTION OF THE INVENTION

If used herein, the term, “comprising” does not prevent the inclusion of any other component, ingredient or step in addition to those specifically listed or provided. The contents of any United States Patent recited herein are hereby incorporated by reference in their entirety. The term “member” as used herein refers to individuals, groups of individuals, or other legal entities. It is to be understood, that other parties, such as individuals who are related to a member may also receive medical services to be charged to a member's account if permission is granted by the member. Such permission may be encoded in a member's account such that the member need not physically be present to authorize the charging of the account at the time service is rendered.

The present invention is primarily designed to provide for payment to medical service providers for services received by members of the association and subsequent conversion of any such charges to debt in a member's account. The member receives periodic statements for medical expenses incurred and paid by the association, and enters into a credit agreement with the association to guarantee payment thereof. Members are selected based on credit worthiness according to standard consumer or other credit rating systems. In addition, the credit association may take a security interest in any asset owned by the member in order to secure the amount of any credit advanced. That is, a member may be accorded a line of credit based on consumer credit worthiness and, upon the furnishing of additional collateral, may be accorded an additional line of credit. Interest is charged to the member according to standard business practices in the event a charge occurs in the member's account and the outstanding balance on the account is not paid within a normal billing period. In addition, members may be assessed fees in order to join or remain a member of the association. With respect to all accounts, standard billing practices normally employed in the consumer credit business and all normal business practices related to consumer credit practices may be utilized.

Covered medical expenses may include charges for services rendered by physicians, counselors, nurses, therapists, hospitals, clinics, dentists, optometrists, opticians, or other individuals or organizations, costs for medicines, supplements, treatments or any other expense incurred in relation to health maintenance or restoration, or expenses incurred for any other service agreed to by the association, such as veterinary services, treatments by alternative healers or other unconventional practitioners. All such sources of medical expenses are referred to herein as “medical service providers” or merely “service provider”. The service providers are selected based on agreement to accept payment from the credit association for services rendered to members at pre-negotiated or discounted rates, or at least rates that are no higher than rates charged to others receiving one or more group discounts, or such other criteria as the association may agree to. The service provider is benefited in this regard, because payment is certain or is received substantially contemporaneous with the delivery of services. At the same time, members of the medical credit association are assured that the charges incurred for services received are as low as possible, and not influenced by concerns of the medical provider regarding ability to pay. In addition, the association does not interfere in the member's choice of medical treatment or limit the options for which payment will be made, other than the maximum amount of each member's credit limit. For the foregoing reasons, the negotiated rates for reimbursement for medical services provided to members of the association may actually be less than rates charged for services provided to insured patients.

The manner in which fees are pre-negotiated with the association may involve use of similar codes for medical services already employed in the medical insurance billing profession along with suitable charges for any such services, established, for example, by use of bench-mark surveys to determine customary and reasonable charges for equivalent services in a geographical region. Alternatively, the service provider may agree to charge the same fee as is charged to other discounted groups or a rate that is the same as charged to a person paying cash, if such would be less than the rate charged to other third party payers. The association and individual medical service providers may employ any suitable method for arriving at agreeable negotiated rates for performing any services hereunder, including use of an automated method for providing evaluation and management (E&M) CPT codes for services provided. An example of such a system is disclosed in U.S. Pat. No. 6,529,876. Any suitable means for contracting or otherwise signifying consent to the terms and conditions for payment by the association may be employed. The association may audit the billings of a service provider to ensure compliance with agreed to rates.

In contrast to medical insurance, each member remains obligated to pay for medical services received under the present business method, however, payment is made by the member to the association rather than to the medical provider and may be deferred or paid in installments, along with any interest or other charges assessed by the credit association. Beneficially, the member is assured that costs for any services provided are equivalent to or less than the lowest cost charged by the medical provider, and that unforeseen medical expenses will be able to be paid by installment. Necessary medical treatment will therefore not need to be forgone due to a member's fear of excessive or inflated charges or an unwillingness of the provider to give treatment. In addition, no stigma is associated with the fact that the association member chooses to pay for services received, rather than to purchase medical insurance. The medical service provider is benefited, due to the fact that payment is immediate or assured, no interference with the choice of treatment options or the patient-physician relationship takes place, and carrying costs, defaults, and other charges are avoided.

The medical credit association profits by charging interest for any credit extended to its members, as well as any service fees, membership fees, or other charges agreed to be paid by the member. By pre-selecting members based on credit worthiness, collateralizing or acquiring security interests where suitable, and accessing lower cost financing options available for larger entities, the association can provide members with a line of credit for use in the eventuality that medical expenses are incurred, at interest rates that are near or equivalent to ordinary consumer credit interest rates. Unlike insurance, members pay only for services received and do not pay large premiums in order to cover the costs incurred by other insured parties. For the foregoing reason, over-use or abuse of medical treatment according to the present business method is reduced, due to the fact that customers or members remain liable for all charges applied to their accounts.

In addition to other features of the present method, it is within the scope of the present method to permit members to combine a medical savings account with the present credit account such that payments may be deducted automatically from the medical savings account in order to pay for sums advanced on the credit account. An example of one method for integrating such a medical savings account is previously disclosed in U.S. Pat. No. 6,108,641. In this manner of operation, there is provided a data processing system for managing a plurality of accounts, wherein each account includes at least a member's master account, and a medical savings account, comprising:

master account processing means for creating and controlling a master account;

master account input means for receiving account transactions from said individual corresponding to account activity inquiries and account asset transfers into and out of said master account;

subaccount processing means for creating and controlling one or more medical savings subaccounts associated with said master account, wherein said subaccount processor permits a particular profile of subaccount transactions to be associated with each said subaccount, said profile representing a subset of transaction functions or identifications associated with said master account;

paperwork control means for generating necessary paperwork associated with each master account and each of said medical savings subaccounts, for sending such paperwork to said individual, and for determining that such paperwork has been received from and completed by said individual; and

account reporting means for creating and displaying or outputting reports of transactions undertaken for said master account and said one or more medical savings subaccounts on a regular periodic basis;

wherein payment for charges incurred in the master account may be automatically deducted from at least one of said medical savings subaccounts.

The medical credit association may also provide additional, traditional consumer type credit services to members, if desired. For example, the members may elect to purchase credit insurance to pay the amounts due in their account in the event they are unable to do so. The member may also elect to purchase contingency insurance, to provide an additional credit reserve, beyond a member's preauthorized credit limit, for use in the event of an emergency. Additional or higher interest charges may also be assessed for extending credit to a member in excess of preauthorized credit amounts. Perhaps the biggest benefit to members however, is the ability to receive pre-negotiated or reduced fees for services, so that the member is assured of receiving the lowest cost medical treatment available. Any federal or state laws regarding fair credit, billing practices, and consumer rights, depending on the appropriate jurisdiction, will apply to the relationships of the association with its members.

It is to be understood that the application for membership in the association (applying for a medical credit account) may be by use of an automated, “closed-loop” system, such as the system disclosed in U.S. Pat. No. 6,105,007, wherein some or all steps are performed by one or more automated devices or computers. An example of a suitable process conducted while the applicant is using a remote terminal or interface comprises an automatic account processing system, comprising:

a.a remote interface adapted to:

i. allow an applicant to remotely request a medical credit account; and

ii. receive data from an applicant;

b. a data processing system with associated memory having establishment criteria bearing on the ability and willingness of the applicant to comply with account requirements for establishing and holding a medical credit account based on prescribed data obtained from the applicant and information about the applicant obtained from at least one database containing information about the applicant relevant to the ability and willingness of the applicant to comply with the account requirements;

c. a communication network electronically coupling said data processing system to said applicant interface;

d. without human assistance, said data processing system adapted to:

i. receive the data from the applicant received at the remote interface;

ii. access the at least one database for information relevant to the applicant's identity and for the information relevant to the applicant's ability and willingness to comply with the account requirements;

iii. verify the applicant's identity by comparing certain of the information received from the applicant with certain of the information received from said at least one database relevant to the applicant's identity;

iv. compare certain of the information received from the applicant and certain of the information received from said at least one database relevant to the applicant's ability and willingness to comply with the account requirements to determine in real time and without human assistance if the applicant's requested account is approved; and

v. informing the applicant whether or not establishment of the requested account was successful.

As a business method, the present invention provides several unique advantages. Customers or members may be provided with a card or other evidence of membership in the association, such as a card containing machine readable information concerning their account, which may be in magnetic or other suitable form, in a manner analogous to the well known consumer credit card. The information may be encrypted or password protected, if desired, to prevent unauthorized access. In so far as the card is used to pay for receipt of medical services, incidences of consumer fraud are likely to be extremely rare, since the service provider would be generally reliable in identifying and supplying services only to the individuals authorized on the account, such as the named individual and family members only, and other uses, especially purchases of general consumer merchandise, may be restricted or prohibited. Thus, losses to the association due to fraud are likely to be extremely low. The card, if carried on the person or otherwise available, would also serve to inform a medical service provider of the identity of the individual and the fact that services may be provided without risk of non-payment, in the event the customer or member is incapacitated or otherwise unable to respond to questions regarding treatment. This unique benefit of membership may be selected by a member or not, and could be encoded in the information available in a member's account, to specifically authorize certifiable informed consent to receive medical treatment if the member is incapacitated and unable to provide such consent. Additional medical information such as the member's blood type, known allergies, and other medical history may be included in the member's account information for use by an emergency responder or other health professional, if needed. The association and member may enter into an agreement at the time the account is established in order to provide any required consent to disclose medical information under applicable privacy laws.

In this regard, it is within the scope of the present invention to provide a method for establishing certifiable informed consent and/or consent to release of medical information for treatment or billing purposes and providing evidence of such fact in a retrievable manner to a remote service provider from information in or associated with a member's account. One suitable method, for example, could involve a computer generated system such as is disclosed in U.S. Pat. No. 6,516,300. As one example, an emergency responder service provider may employ a remote access communication device, such as a cellular telephone, wireless internet connection, or other communication device to access information concerning a member requiring emergency assistance through a central computer interface. By entering the encrypted account information the service provider is assured that a member has provided informed consent to emergency procedures that may be provided and is quickly informed of any required-medical information concerning the member in order to assist in treating the member.

Not withstanding the foregoing intended uses, it is to be understood that the association may permit members to use their accounts for purchases of general consumer merchandise or services, if desired. That is, the use of the member's accounts for general purchases need not necessarily be prohibited under the present business method, it being understood that the benefits of prenegotiated cost structures would not necessarily accrue for any uses of the member's account to purchase goods or services other than through service providers who are under contractual obligation to the association to provide reduced or negotiated fees or charges, and any personal medical information would be inaccessible to other than a medical service provider. Thus, the association may permit a member to also use their accounts in the same manner as a consumer credit card account, if desired. In order to access or use their credit, members may be issued a suitable card or other media containing information or data therein. Such general consumer credit information would be segregated from medical information concerning the member, and only accessible through entry of a separate passcode or authorization means. For example, emergency medical personnel may be asked to obtain a separate pass code by calling a separate telephone number or other address, in order to verify the appropriateness of receiving a member's personal medical information. The information residing in such card or other media may be processed by the medical service provider to conduct a transaction using well known procedures. Suitable methods for processing such information have been previously disclosed in U.S. Pat. No. 6,488,205. A particular system, especially adapted for processing of medical transactions, has been disclosed in U.S. Pat. No. 6,453,297.

As one possible means for operating the present method, a service provider may automatically charge a member's account for services rendered by:

establishing a communication link with a central computer containing information concerning the member's account;

submitting information identifying the service provider, the member, and amount of charges; and

receiving from the central computer an acknowledgment if the charge is accepted,

characterized in that the identifying information concerning a member's account is encrypted in machine readable form in a memory device.

The service provider may receive payment for charges by directly charging a member's account through use of a communication device, such as a terminal or telephone modem that is in communication with a computer having access to a member's account information stored in memory or in a retrievable file accessible by the computer. The communication link to the computer may be via a telephone connection, an internet connection, a wireless connection, or other suitable means for data transfer. A member's card may be employed to provide secure account access, such as through a machine readable series of instructions in magnetic or electronic form. A microchip containing machine readable coded information that is embedded in the member's card may be employed as well. In addition to the member's account information, additional medical information may also be stored in such a machine readable device, including without limitation, information on the individual's blood type, any preexisting medical condition and any known allergies. Alternatively, such information may reside in a central data base which is accessible or linked to a member's account information. Suitable systems for storing and accessing a member's account information are well known to the skilled artisan and equally applicable for use in the present business method. An automated billing system, such as the one disclosed in U.S. Pat. No. 6,655,583 may be employed by the service provider, if desired, in order to calculate the amount to charge a member's account for services provided.

### EXAMPLES

Having described the invention the following examples are provided as further illustrative thereof and are not to be construed as limiting the invention.

### Example 1

Person A, an unskilled laborer, is not able to afford group health insurance. He applies for membership in the association, paying a $39.00 yearly membership fee. He is accepted and receives a card containing his account information encoded in a magnetic strip. Based on an annualized income of $17,000, he is extended a $5,000 line of credit to be used for medical services. After one year he has used the account to charge for two visits to a physician, who's discounted fees were 20 percent less than fees charged other negotiated, private health plans because payment is received in full at the time services are provided. He pays the balance due on his account within each billing period and does not pay interest charges or late fees.

### Example 2

Person B, owns a small business, and does not desire to purchase health insurance due to the cost. He applies for membership in the association, paying a $39.00 annual membership fee. He is accepted and receives a card containing his account information encoded in a magnetic strip. Based on an annualized income of $42,000, he is extended a $15,000 line of credit to be used for medical services. During the year he requires the services of a specialist in internal medicine at a hospital. Normally, the hospital, a non-profit institution would charge an uninsured patient $25,000 for the services provided to Person B. However, due to a negotiated rate structure in the agreement between the association and the hospital, the fees are reduced to $12,500, the same amount charged to other medical insurance plans for the same services. The hospital is paid in full by the association and Member B's account is charged for $12,500. He pays the minimum balance due on his account within each billing period and finances the remainder at standard consumer interest rates. At the end of the year, his remaining unpaid balance is $9,000.

### Example 3

Person C is a farmer. Based on personal credit worthiness he applies for membership in the association paying a $39.00 annual application fee to join and is extended a $10,000 line of credit in his account. In addition, he requests an additional credit line secured by the equity in his house and farm, and pays an additional fee for preparation of a suitable contingent mortgage. Based on the available equity he receives an additional $100,000 line of credit payable over 60 months from the time of incurring an expense in excess of $10,000, with a choice of amortizing the entire debt over 60 months at a rate pegged to secured, mortgage backed financing rate rather than unsecured consumer interest rates. Later in the year, Person C requires surgery and is hospitalized. Prior to entering the hospital Person C executes a lien to cover the expected costs of the surgery. Because a prenegotiated rate has been established between the hospital and the association the total cost of the surgery ($17,000) is paid by the association and Person C's account is charged for this amount. Person C chooses to amortize the entire amount of the debt over 60 months at standard adjustable mortgage interest rates in effect at the time the charge is incurred. The previously executed lien on the house and farm is recorded at the time the charge is incurred.

What is claimed is:

1. A business method that provides for payment of medical expenses received by or on behalf of members of an association, comprising,
establishing contractual agreements between the association and a multiplicity of medical service providers that are obligated to provide medical services to members of the association at rates that are pre-negotiated or otherwise agreed to with the association;
extending to members of the association a line of credit to be used to pay for medical services received from any of said medical service providers;
paying said medical service providers for services rendered to said member according to the prenegotiated or otherwise agreed to rate schedule;
charging the member's account for payments made to a medical service provider for services received by the member; and
receiving reimbursement from the member for amounts so charged to the member's account.

2. The method of claim 1 wherein the member is charged interest for any amounts 15 charged to the account and unpaid after a fixed time period.

3. The method of claim 1 wherein the member is additionally charged a fee for membership in the association.

4. The method of claim 1 wherein the member is charged a transaction fee for each payment made to a service provider on behalf of a member.

5. The method of claim 1 wherein a service provider is charged a fee for each payment received from the association.

6. The method of claim 1 wherein charges for goods or services by other than medical service providers are also permitted to be charged to the member's account.

7. The method of claim 1 wherein a member provides prior consent to the association to charge said member's account for delivery of medical services by a medical service provider in the event the member is unable to provide informed consent to such medical treatment at the time of receipt thereof.

8. The method of claim i wherein a service provider may automatically charge a member's account for services rendered by:
establishing a communication link with a central computer containing information concerning the member's account;
submitting information identifying the service provider, the member, and amount of charges; and
receiving from the central computer an acknowledgment if the charge is accepted,
characterized in that the identifying information concerning a member's account is encrypted in machine readable form in a memory device retained by the member.

9. The method of claim 8 wherein the memory device is a card containing the member's account information in a magnetic strip.

10. The method of claim 1 wherein the medical service provider uses an automatic billing generator to charge the member's account.

11. The method of claim 1 wherein in addition to a members credit account (master account) there is associated a medical savings account such that payment for charges assessed to the account are automatically deducted from the associated medical savings account.

12. The method of claim 1 wherein a member's medical credit account is established by an automated system adapted for evaluating a member's credit worthiness based on information supplied by an applicant.
